(19) United States
(12) Patent Application Publication
(10) Pub. No.: US 2007/0017456 A1
(43) Pub. Date: Jan. 25, 2007

(54) Training device

(75) Inventor: Terry Huett, Logan Village QLD (AU)

Correspondence Address: YOUNG & THOMPSON, 745 SOUTH 23RD STREET, 2ND FLOOR, ARLINGTON, VA, 22202, US

(73) Assignee: TERRY HUETT AND JANICE HUETT, LOGAN VILLAGE QLD (AU)

(21) Appl. No.: 11/481,891

(22) Filed: Jul. 7, 2006

(30) Foreign Application Priority Data
Jul. 19, 2005 (AU) 2005903790

(51) Int. Cl. A01K 15/02

(52) U.S. Cl. 119/839

(57) ABSTRACT

A horse and/or rider training device including, a mobile device which is remotely-controlled and having a surrogate animal secured upon the mobile device, a remote-controller which transmits movement commands to the mobile device, wherein the mobile device is adapted to allow a user to control movements of the mobile device through the remote-controller.

### FIELD OF THE INVENTION

The present invention relates to a training device, in particular a device for training a horse and/or rider to perform certain tasks.

### DESCRIPTION OF THE PRIOR ART

Training horses and riders to perform specific tasks can be a time consuming exercise, especially when training for a particular event. Competition training for horse and rider can be quite intense; therefore it is undesirable to use “live” animals during training because of the stress imposed on the animal during training. To alleviate the problem there are a number of documents which have attempted to address this problem.

U.S. Pat. No. 4,738,223, discloses a horse training apparatus. The document details a linear cable system where a support post is located opposite to a bi-directional drive unit. An artificial calf is suspended from the cable, while an operator controls the direction of the calf by an operating lever. Though the document provides a system to train horses, it is limited to movement in a linear path and would require a substantial setup time.

U.S. Pat. No. 5,325,817, discloses another training device, in particular it refers to a device for training horses to herd cows or calves. A circular mounted track where an artificial calf is pneumatically driven to travel around the track to simulate the movement of a calf. While the disclosure was novel at the time, the apparatus is limited to a confined area of the mounted track and it also lacks practical versatility.

While EP 1 298 984, discloses an automatic horse training system, specifically a fully automatic racehorse training system which does not require any human interaction with the horses. Horses are automatically lead from a stable into a confined area within a horse training device. When the horse is within the horse training device, the horse training device travels around the perimeter of a racecourse to simulate a race. Though this document offers an alternative to conventional racehorse training, it could be considered by many as unorthodox. In addition, the system prevents any interaction between the rider and horse, which for many would be unappealing.

Considering the existing options it would be advantageous to at least substantially ameliorate the disadvantages and shortcomings of the prior art, or at least provide the public with a useful alternative.

### SUMMARY OF THE INVENTION

This invention resides broadly in a horse and/or rider training device including,
a mobile device which is remotely-controlled and having a surrogate animal secured upon the mobile device,
a remote-controller which transmits movement commands to the mobile device,
wherein the mobile device is adapted to allow a user to control movements of the mobile device through the remote-controller.

Preferably, the mobile device has at least one drive wheel and at least one idler wheel.

Preferably, the drive wheel rotates a track belt.

Alternatively, the mobile device has at least one castor wheel.

Preferably, the mobile device has an electrical motor.

Preferably, the electrical motor has a re-chargeable battery.

Preferably, the remote-controller controls the direction and speed of the mobile device.

Preferably, the remote-controller has a joystick to control the movement. Alternatively, the remote-controller has a dual-lever controller, wherein one lever controls one drive wheel while the other lever controls the adjacent drive wheel.

Preferably, the surrogate animal simulates a type of livestock. Examples of livestock may include a calf, a cow or a sheep.

Preferably, the training device is used for training in competition events. Examples of competition events may include camp-drafting, rope and tie, steer wrestling and team roping.

Alternatively, the training device is used for training in livestock herding.

In another preferred version, the training device includes microprocessor means, wherein a number of movement commands can be programmed for the mobile device to execute one or more training manoeuvres or routines.

In another embodiment of the invention, the invention resides broadly in a method of training a horse and/or rider utilising a training device, the training device comprising
a mobile device which is remotely-controlled and having a surrogate animal secured upon the mobile device,
a remote-controller which transmits movement commands to the mobile device,
wherein the mobile device is adapted to allow a user to control movements of the mobile device through the remote-controller.

### BRIEF DESCRIPTION OF THE DRAWINGS

In order that the present invention may be readily understood and put into practical effect, reference will now be made to the accompanying illustrations wherein:

FIG. 1 is a side elevated view of a horse and/or rider training device according to a preferred embodiment of the invention with a track belt,

FIG. 2 is a perspective view of a mobile device according to the preferred embodiment of the invention,

FIG. 3A is another perspective view of the mobile device,

FIG. 3B is a front elevated view of the mobile device,

FIG. 3C is a bottom elevated view of the mobile device,

FIG. 3D is a side elevated view of the mobile device,

FIG. 4 is a side elevated view of a horse and/or rider training device according to another embodiment of the invention with castor wheels,

FIG. 5A is a perspective view of a mobile device according to another embodiment of the invention,

FIG. 5B is a front elevated view of the mobile device,

FIG. 5C is a bottom elevated view of the mobile device,

FIG. 5D is the side elevated view of the mobile device.

### DETAILED DESCRIPTION OF THE DRAWINGS

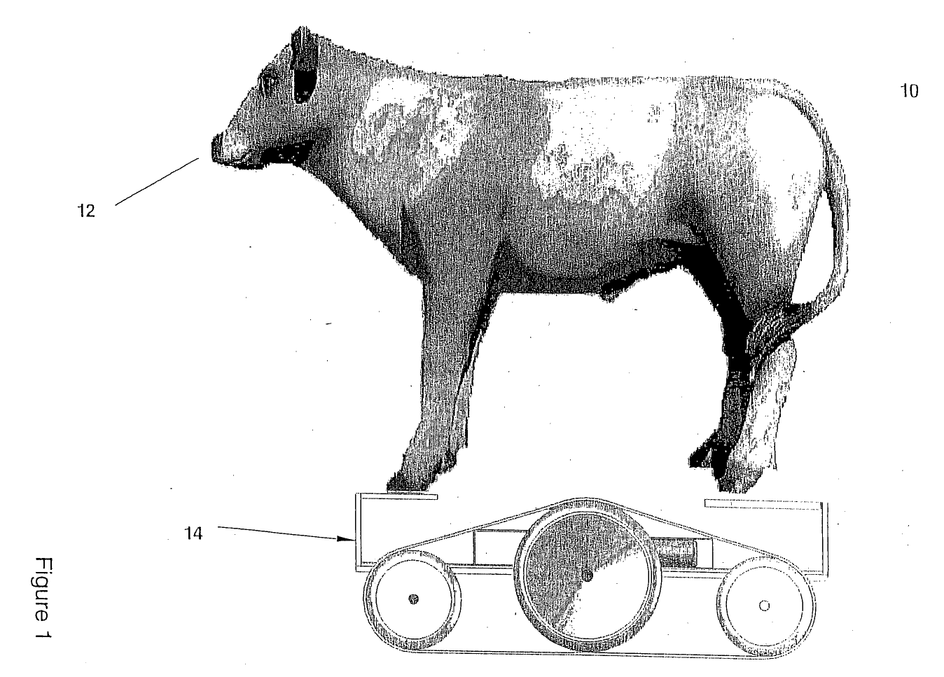

FIG. 1 shows a horse and/or rider training device according to a preferred embodiment of the invention. The horse and/or rider training device 10 as illustrated in FIG. 1 comprises a surrogate animal 12 and a mobile device 14. Although not shown, the surrogate animal 12 can be fastened to a mounting plate of the mobile device 14 by a number of suitable means. In addition, the surrogate animal 12 may be detachable from the mounting plate. This would allow the horse and/or rider training device 10 to be transportable and allow maintenance on either the surrogate animal 12 or the mobile device 14 to be relatively convenient. Although the surrogate animal 12 depicted in FIG. 1 is of a calf, it could be easily understood that the surrogate animal 12 could be a number of different animals depending on the required simulation. Such examples could include a cow or sheep.

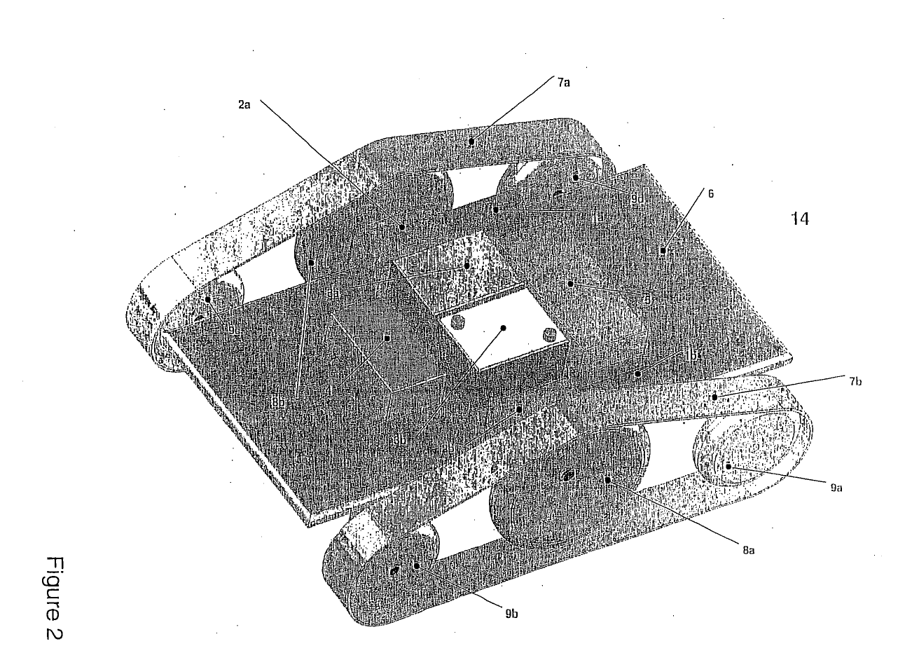

FIG. 2 provides a perspective view of the mobile device 14 in greater detail. The mobile device 14 comprises two electric motors 1a, 1b, in connection with two reduction gearboxes 2a, 2b which are located adjacent to two main drive wheels 8a, 8b. The mobile device 14 further comprises two battery units 3a, 3b located in the approximate centre of a main unit body 6 and four idler wheels 9a, 9b, 9c 9d. Although not shown, a conventional remote control unit sends signals to a remote control receiver 4 which is in connection with an electric motor-drive electronics 5.

The remote control unit comprises one joystick, which transmits movement commands to the remote receiver 4, which subsequently relays the commands to the electric motor-drive electronics and the electric motors 1a, 1b. By moving the joystick forward from the neutral position, the remote control unit transmits a forward command, which commands both electric motors 1a, 1b to propel forward, thereby propelling the horse and/or rider training device forward. By moving the joystick either left or right, the remote control unit would transmit commands which reduce the propulsion of one of the two electric motors while keeping the other constant, thereby manoeuvring the device in the desired direction. Alternatively, by moving the joystick backwards from the neutral position, the electric motors would reverse and the horse and/or rider training device would reverse. In another embodiment of the invention, the remote control unit may include two levers, each lever directly controlling individual electric motors 1a, 1b.

Preferably the batteries 3a, 3b are sealed, to prevent dust or moisture penetrating the batteries. Also, the sealed battery prevents spillage of battery acids in case of the horse and/or rider training device capsizing. In addition, the batteries 3a, 3b may be re-movable and re-chargeable, allowing for maintenance to be relatively convenient.

The drive wheels 8a, 8b rotate, which in turn rotates the track belts 7a, 7b. The track belts 7a, 7b would also rotate around idler wheels 9a, 9b, 9c, 9d. The track belt can be made from conventional flexible synthetic rubber or any other suitable material. Preferably, the drive wheels 8a, 8b have small sprockets which would engage with the inner side of the track belts 7a, 7b.

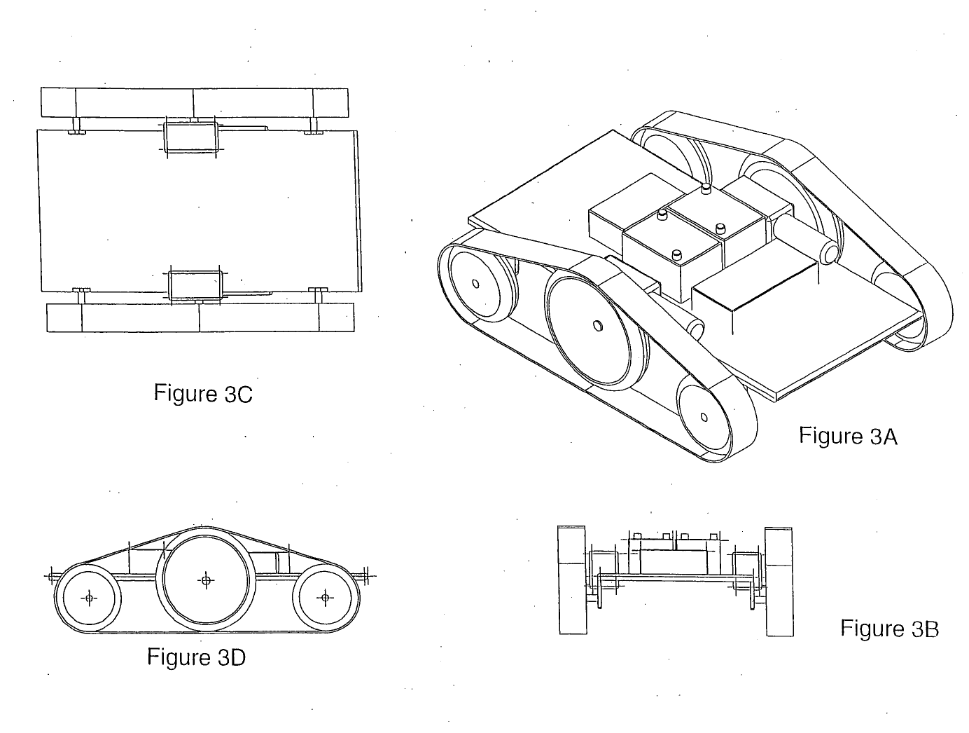

The track belts 7a, 7b as illustrated in FIG. 1-3D would be highly suitable for uneven terrain. This allows the horse and/or rider training device to be used in a number of different locations. Preferably, the device can be used in training for horse events such as camp-drafting, rope and tie, steer wrestling and team roping. Alternatively, the device can be used in training horse and/or rider in herding livestock.

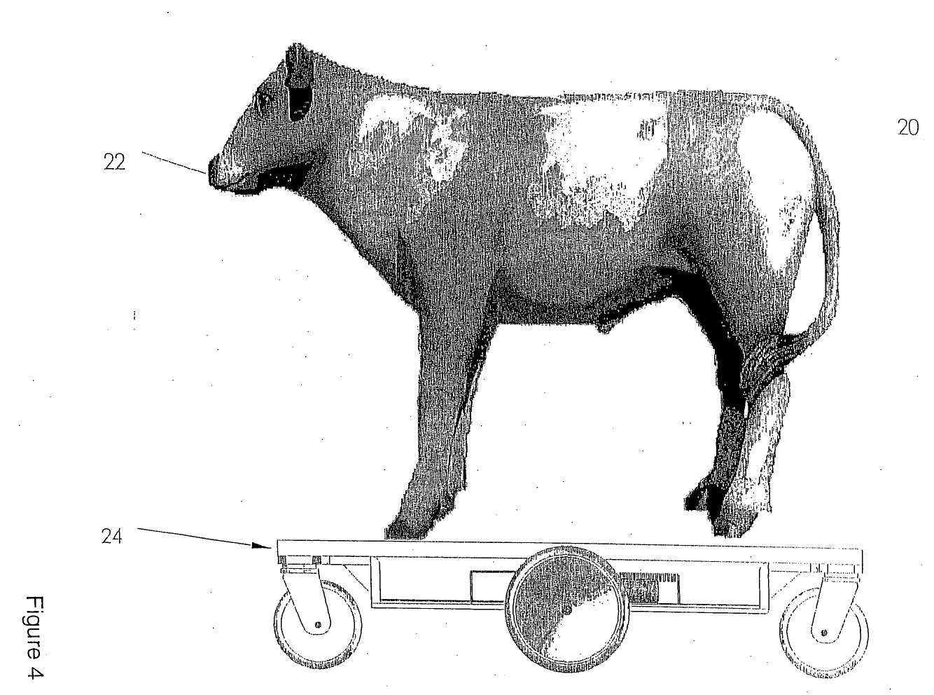

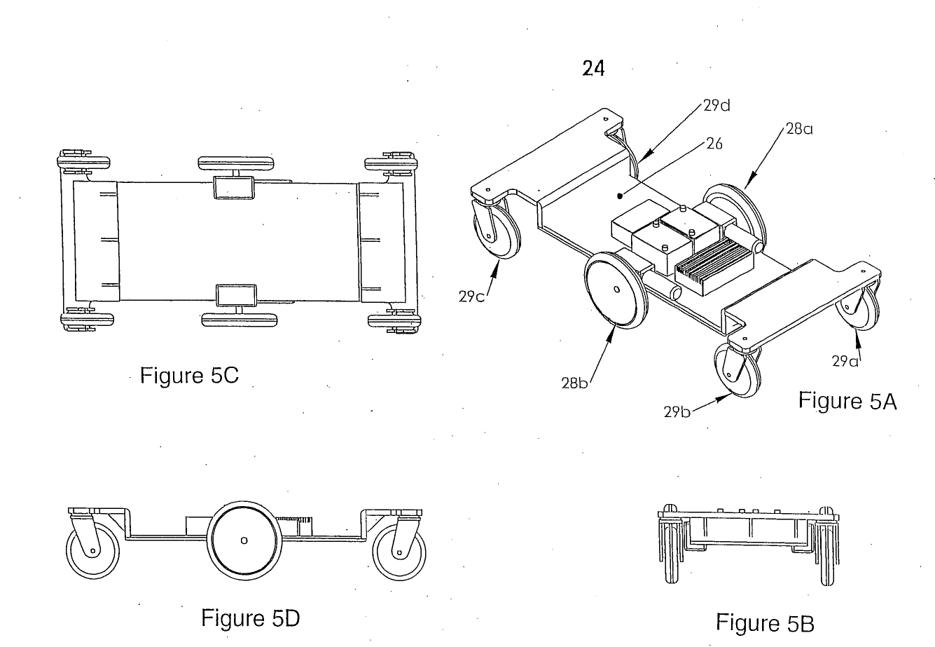

FIGS. 4-5D show a horse and/or rider training device according to another embodiment of the invention. The horse and/or rider training device 20 as illustrated in FIG. 4 comprises a surrogate animal 22 and a mobile device 24. Though this embodiment of the invention is similar to the previously detailed embodiment there are a few distinct differences.

In FIG. 5A, the mobile device 24 comprises two drive wheels 28a, 28b. Instead of track belts as detailed earlier, this embodiment uses drive wheels 28a, 28b. In addition, the main unit body 26 is located on a lower recess of the mobile device.

The principles as detailed earlier, in reference to remote controller, electric motors and general movement controls of the device are also used in this embodiment of the invention. The drive wheels 28a, 28b with castor wheels 29a, 29b, 29c, 29d, provides additional stability to the mobile device, especially when the surrogate animal 22 is attached.

Given the nature of the described invention, the horse and/or rider training device is a portable device with minimal setup requirements, allowing the device to be used in a number of different locations. In addition, the operator can manoeuvre the device in such a way to simulate a number of different situations, which would enhance the training of horse and/or rider.

In a preferred embodiment, the training device may further include microprocessor means preferably activated by the remote controller, wherein the mobile device can be programmed to execute one or more training manoeuvres or routines.

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims of this specification, the word “comprise” and variations of that word such as “comprises” and “comprising”, are not intended to exclude other additives, components, integers or steps.

1. A horse and/or rider training device including,
a mobile device which is remotely-controlled and having a surrogate animal secured upon the mobile device,
a remote-controller which transmits movement commands to the mobile device,
wherein the mobile device is adapted to allow a user to control movements of the mobile device through the remote-controller.

2. A horse and/or rider training device as claimed in claim 1, wherein the mobile device has at least one drive wheel and at least one idler wheel.

3. A horse and/or rider training device as claimed in claim 1, wherein, the mobile device has a drive wheel that rotates a track belt.

4. A horse and/or rider training device as claimed in claim 1 wherein, the mobile device has at least one castor wheel.

5. A horse and/or rider training device as claimed claim 1 wherein, the mobile device has an electrical motor.

6. A horse and/or rider training device as claimed in claim 1 wherein, the mobile device has an electrical motor with a re-chargeable battery.

7. A horse and/or rider training device as claimed in claim 1 wherein, the remote-controller controls the direction and speed of the mobile device.

8. A horse and/or rider training device as claimed in claim 1 wherein, the remote-controller has a joystick to control the movement of the mobile device.

9. A horse and/or rider training device as claimed in claim 1 wherein, the remote-controller has a dual-lever controller, wherein one lever controls a drive wheel while the other lever controls another drive wheel.

10. A horse and/or rider training device as claimed in claim 1 wherein, the surrogate animal simulates a type of livestock.

11. A horse and/or rider training device as claimed in claim 1 wherein, the surrogate animal is a calf, a cow or a sheep.

12. A horse and/or rider training device as claimed in claim 1 wherein, the training device is used for training in competition events.

13. A horse and/or rider training device as claimed in claim 1 wherein, the training device is used for training in camp-drafting, rope and tie, steer wrestling and team roping.

14. A horse and/or rider training device as claimed in claim 1 wherein, the training device is used for training in livestock herding.

15. A horse and/or rider training device as claimed in claim 1 including a microprocessor, wherein a number of movement commands can be programmed to enable the mobile device to execute one or more training manoeuvres or routines.

16. A method of training a horse and/or rider utilising a training device, the training device comprising,
a mobile device which is remotely-controlled and having a surrogate animal secured upon the mobile device,
a remote-controller which transmits movement commands to the mobile device,
wherein the mobile device is adapted to allow a user to control movements of the mobile device through the remote-controller.
